(19) United States
(12) Patent Application Publication
(10) Pub. No.: US 2008/0018675 A1
(43) Pub. Date: Jan. 24, 2008

(54) Mimic gauge for a chart recorder

(76) Inventor: Aubrey Dare Westmoreland, Marshall, TX (US)

Correspondence Address: RUDOLPH J. BUCHEL JR., LAW OFFICE OF, P. O. BOX 702526, DALLAS, TX, 75370-2526, US

(21) Appl. No.: 11/490,584

(22) Filed: Jul. 22, 2006

(51) Int. Cl. G01D 15/04

(52) U.S. Cl. 346/100

(57) ABSTRACT

The present invention is directed to a data logger for electrically recording positions of a motional member in a chart recorder. A mechanical-to-electrical converter translates the mechanical positions into electrical position signals. The mechanical-to-electrical includes a mechanical coupler for securing at least a portion of the converter to a motional member in a mechanical chart recorder and a position sensor for measuring the spatial positions of the motional member as it moves in response to movements generated in a mechanical measurement instrument. The position sensor generates electrical position signals that are fed to a field processor. The field processor transforms the electrical position signals into position data representative of the spatial position by applying a calibration algorithm that uses calibration coefficients determined for the particular position sensor being employed. The position sensor may measure rotational movement, such as from a shaft in the chart recorder, or linear movement, such as from a linkage in the chart recorder. Angular sensors include inclinometers, potentiometers, magnetic field sensors and optical sensors, while linear sensors include potentiometers, magnetic field sensors and optical sensors. Also provided in the field processor is storage capacity for storing data relating to the raw electrical signals or the measurement data, as well as for application software. Optionally, a transmitter may be incorporated in the field processor for transmitting the position information to a remote location.

### BACKGROUND OF THE INVENTION

The present invention relates generally to data logging. More particularly, the present invention relates to a system for capturing mechanically logged data, in real-time, electrically. More specifically the present invention relates to a mimic gauge for mimicking movements of motional members in a mechanical chart recorder.

Chart recorders and data loggers are devices used to record data values derived from various measurement types. Generally, a chart recorder is distinguishable over a data logger in that a chart recorder creates a paper record or log of the input data while a data logger stores data signals electronically, directly to a memory media. The format of paper media may be a continuous strip (or roll) or circular. Recently, data loggers have come into favor in all but a few industries because of their modest expense, flexibility and relatively low maintenance requirements. Data loggers, as well as most types of chart recorders, receive one or more channels of electrical signals, each channel dedicated to a particular measurement. Thus, generically, a data recorder merely stores electronic data on a memory for access in the future.

As a practical matter, however, most data loggers require some amount of programming for adapting to a particular type of data acquisition and sensor being employed for measuring the data. For example, some data loggers require the installation of a data acquisition (DA) card (or board) in a PC for a connection. A special purpose software application is then used to initiate the logger by selecting values for log input parameters (sampling intervals, logging interval, alarms, etc.). The data logger is then deployed in the desired location without the computer and stores each measurement in memory corresponding to a time and date. The data are retrieved by either reconnecting the data logger to a PC with the special purpose software, or detaching a memory media with the data which can be connected to the PC for downloading its onboard data. With the software, the measurement data can be viewed as a tabular listing or reformatted as a chart or graph for summarizing large amounts of data, pattern recognition or correlating channels of disparate data type. Electronic data can be readily combined with electronic data from other log intervals for assembling a continuous historic data record. Data loggers incorporate the latest in digital technology which makes them smaller, more accurate, capable of recording in higher resolution, able to log multiple data channels simultaneously and with a lower overall cost of ownership over chart recorders. More importantly, the electronic data is immediately available for further processing and display generating without first having to translate the data to digital form as is the case with paper chart recorders. Data loggers, and most types of contemporary chart recorders, require the data in an electronic signal form for logging. Consequently, most measurement sensor manufacturers have also migrated to electronic or electrical-mechanical for capability with electronic data loggers. This necessitates the logging site have electrical power available or the logger be battery equipped. In many cases, chart recorders have been relegated to backing up the electronic data in case of a catastrophic memory failure.

Chart recorders antedate data loggers which have replaced them in many applications. Chart recorders are essential where instant visual feedback is necessary and often preferable to data logging in situations which operators do not have the need, opportunity or technical ability to download and view data on a computer, or where no electrical power is available or where electrical interference results in a degradation of electrical measurement signals. Aside from contemporary electronic/electrical data loggers and chart recorders, mechanical chart recorders are known to accurately log two, four or even six measurement channels without using electricity. This class of mechanical chart recorder, typically utilizing a circular chart format, converts mechanical movement generated by measurement sensors into a calibrated pen movement across a revolving circular chart. Mechanical chart recorders remain in widespread use in the oil industry for measuring wellhead, reservoir, pipeline and tank information. Mechanical sensors are available for oilfield applications for a variety of measurements, such as time, pump rate (sucker rod strokes), pressure, differential pressure, temperature, flow rate, fluid level, tank level, GOR (gas oil ratio) and sucker rod strain/column weight. Finished (inked) circular charts are replaced at predetermined intervals with fresh charts based on a rotation rate of the mechanical clockwork drive assembly of the chart recorder. One, two, three, seven and eight day preprinted chart speeds are common for use with corresponding mechanical clockworks.

### BRIEF SUMMARY OF THE INVENTION

The present invention is directed to a mimic gauge for recording positions of a motional member in a chart recorder. The present mimic gauge provides a mechanism for generating electrical measurement data using a mechanical chart recorder that may not have the capability to generate an electrical signal. The mimic gauge includes a mechanical-to-electrical converter for converting spatial positions of a motional member in a chart recorder into electrical signals related to the spatial positions of the motional member. The mechanical-to-electrical converter includes a mechanical coupler for securing at least a portion of the mechanical-to-electrical converter to the motional member of the chart recorder and a position sensor for measuring spatial positions of the motional member and generating respective electrical position signals. A signal connection is also provided for transmitting the electrical position signals from the position sensor. A field processor is electrically coupled to the mechanical-to-electrical converter which includes a data processor for transforming the electrical position signals into position data representative of the spatial position of the motional member, and a memory.

The position member of the chart recorder may be a shaft for transmitting rotational motion or a linkage for transmitting linear motion. Thus, the position sensor may sense the angular position of the motional member or the linear position positions of the motional member. Linear sensors include potentiometers, magnetic field sensors and optical sensors, while angular sensors include inclinometers, potentiometers, magnetic field sensors and optical sensors.

The field processor may also include a temperature sensor for tracking the ambient temperature at the field process, a transmitter for transmitting one of the electrical position signals and the position data to a remoter location and/or a memory includes capacity for storing one of the electrical position signals and the position data. Additionally, the field processor may further make use of a calibration algorithm for transforming electrical position signals into calibrated measurement data representative of readings from a measurement instrument that is mechanically coupled to the chart recorder.

### BRIEF DESCRIPTION OF THE SEVERAL VIEWS OF THE DRAWINGS

The novel features believed characteristic of the present invention are set forth in the appended claims. The invention itself, however, as well as a preferred mode of use, further objectives and advantages thereof, will be best understood by reference to the following detailed description of an illustrative embodiment when read in conjunction with the accompanying drawings wherein:

FIGS. 1A and 1B are diagrams of an exemplary mechanical chart recorder as known in the prior art;

FIG. 2 is a diagram of the logical elements for reconfiguring a legacy recorder to operate as a mimic gauge in accordance with one exemplary embodiment of the present invention;

FIGS. 3A and 3B are diagrams of an exemplary mechanical chart converted for generating electrical signals in accordance with an exemplary embodiment of the present invention;

FIG. 4 is a flowchart illustrating a method for calibrating the sensor of a mechanical-to-electrical converter configured on a mechanical chart recorder in accordance with an exemplary embodiment of the present invention;

FIG. 5 is a diagram of a mechanical-to-electrical converter utilizing a clamshell shaft connection for measuring the inclination angle of the pen arm shaft in accordance with an exemplary embodiment of the present invention;

FIGS. 6A and 6B are diagrams of a mechanical chart recorder utilizing an optical converter sensor for monitoring the angular position of the pen arm shaft in accordance with an exemplary embodiment of the present invention;

FIGS. 7A and 7B are diagrams of a mechanical chart recorder utilizing a linear position sensor for converting changes in angular position to electrical signals in accordance with an exemplary embodiment of the present invention;

FIGS. 8A and 8B are diagrams of the chart recorder using a converter sensor that measures changes in angular position in accordance with an exemplary embodiment of the present invention;

FIGS. 9A and 9B are diagrams of a non-contact type of converter sensor that measures changes in angular position in accordance with an exemplary embodiment of the present invention;

FIGS. 10A and 10B are diagrams of a converter sensor that measures changes in linear displacement using a strain gauge in accordance with another exemplary embodiment of the present invention; and

FIGS. 11A and 11B are diagrams of a converter sensor that measures changes in linear displacement using a special purpose strain gauge in accordance with another exemplary embodiment of the present invention.

Other features of the present invention will be apparent from the accompanying drawings and from the following detailed description.

### REFERENCE NUMERALS IN DRAWINGS

100: Mechanical chart recorder
102 Weatherproof enclosure
103: Case door
104: Door latch/handle/lock
106: Door window
107: Back plane
108: Door hinge
110 Clockwork assembly
112: Chart drive (turret clockworks)
114: Chart drive winder
116: Chart hub
117: Chart hub pin
118: Recorder chart (circular format)
120: Pen mount assembly
121: Ink pen stylus (or fountain)
122: Pen arm sensor)
123: Pen arm shaft clamp (circular)
124: Pen mount body
125: Pen mount body screw
126: Pen mount shaft cap
127: Cap retaining screws
128: Shaft holes (forward and rear)
129: Shaft bushing
130: Pen arm shaft
132: Range arm
134: Range arm shaft clampblock
135: Range arm shaft clampblock screw
136: Drive link
140: Mechanical instrument assembly
142: Static pressure element
143: Tube
144: Element clampblock converter
146: Element drive link
147: Drive link adjustment
200: Improved chart recorder
202: Mechanical-to-electrical converter
250: Field processor
252: Pre-processor (noise filter, analog to digital (A/D) converter, digital to analog (D/A) converter
251: Onboard RAM/ROM
253: Display
254: Data processor
255: User interface
256: Storage
257: Transmitter/receiver
258: Transmission/receive logic
259: Data port
261: Temperature sensor
302: Inclinometer (mechanical-to-electrical converter)
304: Sensor table/shaft lock
305: Sensor shaft lock screw
306: Inclinometer (position sensor)
309: Inclinometer wiring
320: Adapter flange
322: Circuit board
324: Electronic components
502: Inclinometer Mechanical-to-electrical converter
504: Sensor table/shaft clamshell lock
506: Inclinometer (position sensor)
509: Inclinometer wiring
602: Optical converter assembly
604: Mirror table/shaft lock
605: Shaft lock screw
606: Electronic light sensor (CCD, CMOS or other optical position
607: Light source
608: Reflector
624: Electronic components
702: Linear mechanical-to-electrical converter
703: Sensorshaft
704: Sensor table
705: Sensor shaft lock screw
706: Linear position sensor
708: Sensor range arm
802: Linear mechanical-to-electrical converter
804: Sensor table
806: Angular position sensor
808: Sensor magnet
902: Optical mechanical-to-electrical
903: Circular shaft clamp
904: Sensor table
905: Sensor shaft lock screw
906: Optical position sensor
908: Slotted target
924: Sensor electronics
1002: Strain gauge sensor converter
1003: Sensor spring
1004: Sensor table
1005: Sensor shaft lock screw
1007: Circular shaft clamp
1006: Strain gauge
1008: Sensor range arm
1102: Fiber optic strain converter
1103: Optical fiber
1104: Sensor table
1105: Sensor shaft lock screw
1106A: Optical transmitter/coupler
1106B: Optical receiver/coupler
1107: Circular shaft clamp
1108: Sensor range arm
1109: Sensor range arm

### DETAILED DESCRIPTION OF THE INVENTION

Mechanical chart recorders have been in continued use for over one-hundred years (U.S. Pat. No. 716,973 issued Dec. 20, 1902 to G. X. Wittmer, directed to a Recoding Apparatus for Fluid Meters). Conventional mechanical chart recorders are configurable to accurately log multiple channels of measurement data, simultaneously. Prior art chart recorders may be configured with two, four or even six stylus pens that are mechanically driven and thus operate without the need for electricity.

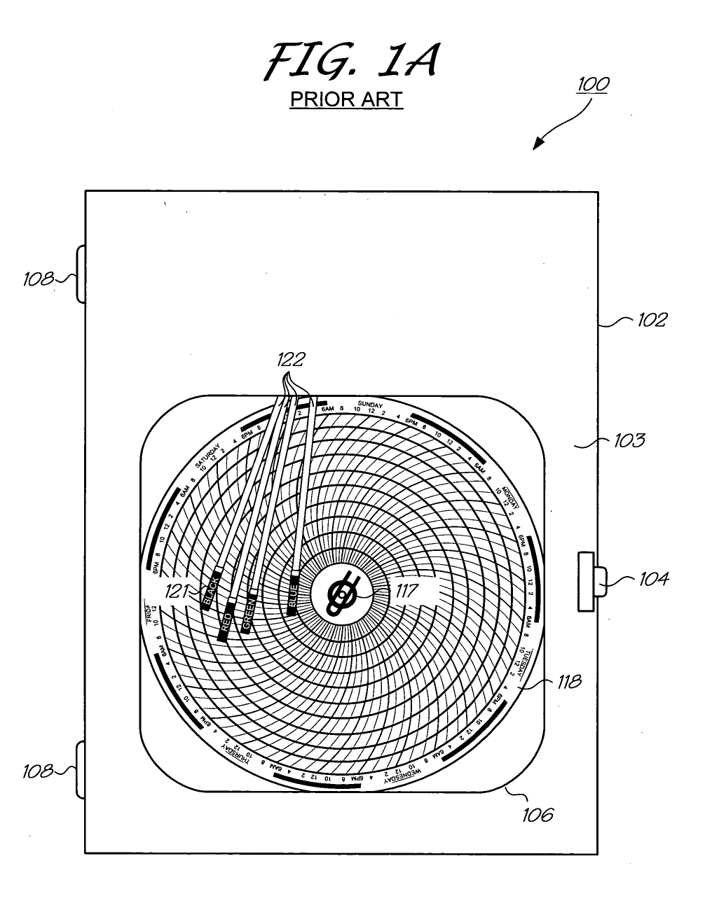

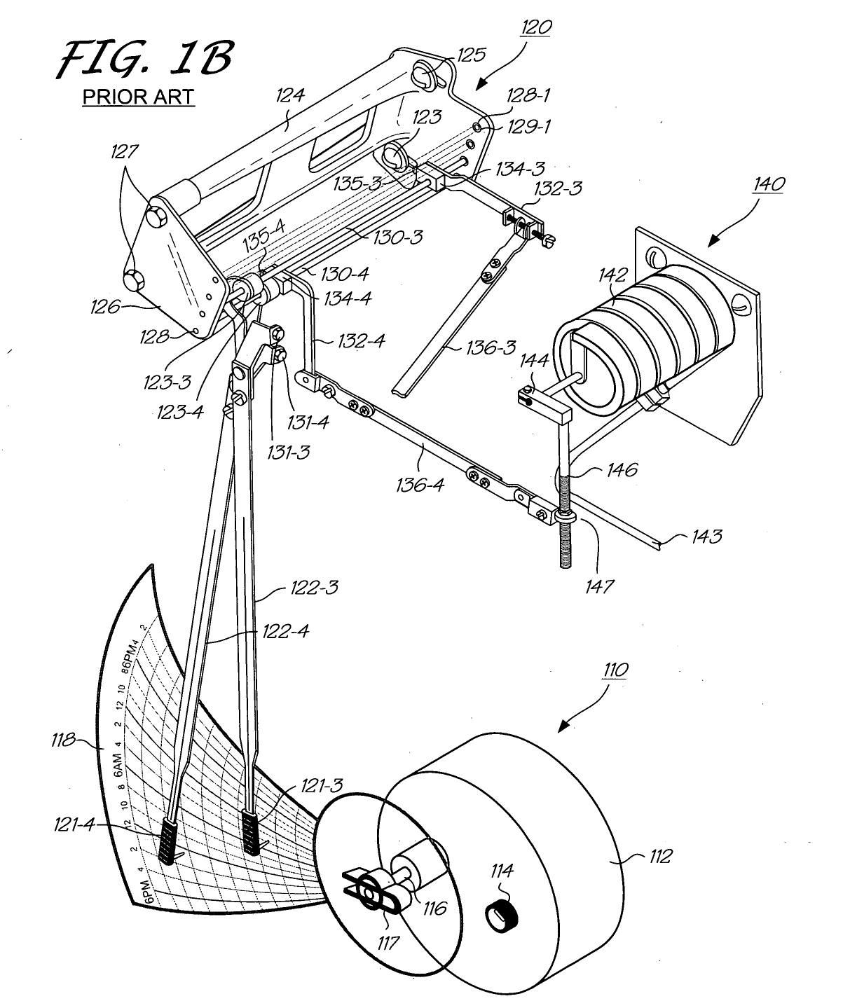

FIGS. 1A and 1B are diagrams of an exemplary mechanical chart recorder as known in the prior art; FIG. 1A depicts a mechanical chart recorder as it is typically installed for service at a jobsite and FIG. 1B is a view of an exemplary mechanical section that internally controls the stylus movements. For clarity throughout the following descriptions, mechanical chart recorder 100 will be referred to as chart recorder 100. However it should be understood that the present invention relates to the class of chart recorders that drive the pen stylus mechanically, with or without the use of electricity, for recording measurement data on a circular chart as it rotates. Chart recorder 100 generally comprises weatherproof enclosure 102 that protects the sensitive internal operating components and paper recorder chart 118 (depicted herein as a circular format chart) from the weather and secures them from unwanted intrusions and tampering by unauthorized persons. As depicted, case 102 comprises access door 103 with hinges 108 for opening and closing door 103 and further comprises handle/latch/lock 104 for opening and closing door 103 to enclosure 102 as well as for securing door 103 to enclosure 102. Transparent window 106 enables the operator to view recorder chart 118 while the recorder is operating and without opening door 103. Notice that the extent of window 106 exposes the full operating area of chart 118. Also visible in window 106 is one or more pen arms 122 and ink pen stylus 121. In order to identify one trace from another, each of ink pen stylus 121 produce a different colored trace record on chart 118, e.g., black, red, green, blue and orange.

FIG. 1B is an oblique view of the internal working components of a typical mechanical chart recorder inside enclosures 102. For clarity, the chart recorder 100 will be described with respect to three general sections comprising chart recorder 100: clockwork assembly 110; pen mount assembly 120; and mechanical instrument assembly 140.

Clockwork assembly 110 provides the rotational movement for turning chart 118 under one or more ink pen stylus 121 that results in a log of the pen movement at predetermined revolutions. Clockwork assembly 110 generally comprises chart drive (turret clockworks) 112 and chart 118. Most often, chart drive 112 is hand-wound mechanical clockworks synchronized to one revolution every one, two, seven or eight days after winding (using an appropriate winding key on chart drive winder 114), however battery powered clocks are available. Internally, a series of reduction gears convert the tension in the wound spring into a rotational force that is delivered to chart hub 116, which holds chart 118 using chart pin 117. It should be appreciated that most turrets are time-synchronized and so a chart with the appropriate printed time scale should be used in conjunction with the particular turret clockworks installed in the enclosure. Chart drive 112 is fitted to back plane 107 of enclosure 102 using rigid fasteners that allow for easy removal and replacement with a chart drive having different clockwork, in order to accommodate different applications with the same recorder unit.

Pen mount assembly 120 comprises the structural components for converting linear movement produced by the individual mechanical sensors into a calibrated rotational movement to the respective pen arms 122-1 thorough 122-n. Preferably, chart recorder 100 is operated in a generally vertical orientation, with chart 118 in a vertical plane that is parallel with back plane 107 of enclosure 102. As installed for operation, back plane 107 is substantially vertical. As mentioned above, prior art chart recorders can accommodate up to six individual measurements (the exemplary recorder having the capability of recording four separate measurements but being fitted for recording two). Pen mount assembly 120 includes pen mount body 124 which fastens to the back plane of enclosure 102 with screws 125 and extends outward from the back plane in a generally horizontal direction. The purpose of pen mount body 124 is to provide a rigid framework for holding one or more pen arm shafts 130 in a generally horizontal orientation, while enabling each shaft to freely rotate about its axis. Pen mount shaft cap 126 is removablly mounted on pen mount body 124 with screws 127 that traverse pen mount shaft cap 126 into threaded holes in pen mount body 124 (not shown). Pen mount body 124 includes rear holes 128 for receiving shaft bushings 129 which correspond and are aligned to front holes 128 disposed within pen mount shaft cap 126. Pen arm shafts 130-1 through 130-n are rotatably connected between bushing in front holes 128 on pen mount shaft cap 126 and rear holes 128 on pen mount body 124. Shaft bushings 129 allow pen arm shafts 130 to rotate freely within pen mount body 124. Additionally, pen mount shaft cap 126 is easily removed for adding or removing individual pen arm shafts 130 for a particular application or for performing regular maintenance.

Pen arms 122-1 through 122-n are secured to respective pen arm shafts 130-1 through 130-n by pen arm shaft clamps 123, located at the shaft end of the respective pen arms (i.e., distal to the pen stylus). Often the shaft holes are aligned in a line that is oriented slightly askew to hub 116 in order to give each shaft and its associated linkage the space to rotate unimpeded, i.e., without interfering with the movement of the adjacent pen shafts. Approximately 30° to 45° of unimpeded movement is necessary to assure full scale (range) pen deflections, which correlated to the typical range of pen movement and varies by chart recorder.

Each of pen shafts 130-3 and 130-4 receives an input movement that is translated to corresponding pen arm 122-3 and 122-4 as a rotational movement. The principle of operation is rather uncomplicated, a mechanical measurement sensor monitors a particular log parameter and senses change in its value, e.g., temperature, pressure, tank/fluid level, etc. The mechanical measurement sensor produces a mechanical movement in response to changes in the parameter value. That movement, through a connected mechanical linkage, causes a pen shaft to rotate, which in turn causes a pen stylus to deflect across the chart and leave a trace as the chart revolves around its axis. The deflection of the pen stylus is calibrated for the particular chart record for accuracy (typically by using a slope-intercept algorithm (e.g., y=mx+b) for adjusting the pen motion. In any case, and as depicted in the figure, motion from a mechanical sensor is conveyed on drive link 136 and then transferred to range arm 132. Range arm 132 converts that linear motion obtained from the movement of drive link 136 to a rotational motion on pen arm shaft 130 (the maximum amount of rotation for the measurement deflection of the mechanical sensor can be preserved by maintaining an approximate right-angle between the motion of the drive link and the pen shaft). As can be understood from the figure, range arm 132 may be straight or angular depending on the position and orientation of the corresponding drive link. In any case, range arm 132 is adjustably coupled to pen shaft 130 by range arm shaft clampblock 134 and secured using range arm shaft clampblock screw 135.

Typically, each chart recorder is fitted with one or more (up to six) mechanical measurement sensors that convert a parametric measurement reading into mechanical movement. Parametric values of interest for the oil industry, and measured at a wellhead, pipeline or tank battery include time, pump rate (sucker rod strokes), pressure, differential pressure, temperature, flow rate, fluid level, tank level, GOR (gas oil ratio) and sucker rod strain/column weight. However, as should be expected the use of this type of device is commonplace in other industries and the recorders are configured with mechanical measurement sensors that for parametric measurements important to those industries. As depicted in the figure, mechanical instrument assembly 140 is configured with static pressure element 142. Static pressure element 142 is open to tube 143. Pressure in tube 143 results in static pressure element 142 unwinding proportionally with the amount of pressure present in the tube. Pressure element 142 is a precision wound helical-type available in a variety of materials and typically available in pressure ranges from 0-30″ mercury vacuum (0-14.7 PSI/1 bar) to 0-10,000 PSI (0-689 bar). Another common mechanical sensor for thermal systems (not shown) consists of a bourdon tube, a capillary, and a mercury filled bulb. Element clampblock 144 connects the concentric shaft of static pressure element 142 to adjustable element drive link 146 (element drive link adjustment 147). In this case, the rotational movement generated by static pressure element 142 is converted to a linear movement and translated to range arm 132-4 via sensor link 136-4, which rotates pen shaft 130-4. To ensure maximum dynamic range, angles formed between element drive link 146 and sensor drive link 136-4, as well and between sensor drive link 136-4 and range arm 132-4 should be set at approximately 90°. Calibrations include adjusting the drive link(s) and range arm for maximizing the dynamic range of the pen travel and then, with the mechanical sensor's input disconnected, zeroing the position of the pen to the chart zero curve using zero screw 131. The calibration is performed for each pen.

Chart recorders and data loggers provide the invaluable function of recording important information without a human presence. Data recorders and electrical chart recorders rely on a power source for their operational power, as do the sensors that receive information. However, as described thoroughly above, a class of legacy chart recorder exists that have proven themselves for reliably delivering log records using only mechanical operating power. These recorders convert mechanical movement generated by measurement sensors into a calibrated pen movement across a revolving circular formatted chart. Mechanical chart recorders remain in widespread and continued use in the oil industry for measuring wellhead, reservoir, pipeline and tank information.

The well head operation for a typical oil well is designed to be self-sustaining, requiring little or no human intervention for long periods. Flowing wells (i.e., wells with sufficient aquifer pressure for conveying hydrocarbon to the surface, water or gas drive) are generally connected to a transmission network pipeline which route the flow of oil and gas from the well to a community separator and then on to separate oil and gas storage tanks that are periodically emptied. Even pumping wells (i.e., wells that rely on a mechanical pumping unit to lift the hydrocarbon from subterranean depths) may be self-sustaining by using reservoir gas that exhausts from the hydrocarbon to drive a pumpjack motor (either by fueling a combustion engine directly, or if the pumpjack is driven by an electric motor, using the natural gas to fuel a gas/electric generator that drives that recharges batteries that power the electric drive motor). These systems are designed to operate in locations where A/C line power is unavailable.

Prior art mechanical chart recorders provide oil field operators with a generally trouble-free and low maintenance device for logging important data at the wellhead, storage tank or pipeline, even those sites that are too remote for the economical delivery of electrical power. However, if a failure occurs, the prior art does not provide a means for recovering lost data for a mechanical recorder. The various types of data generated by remote oil field operations is essential for determining the amount and ownership of oil obtained from a particular well (especially in cases where the oil is stored in a community tank), as well as gauging the amount of salt water production from a particular well or unit, maintaining the integrity of the hydrocarbon reservoir, allocating operating expenses between individual wells or units, establishing production patterns and reservoir parameters and providing a record to royalty and land owners, and the presiding natural resource governing agency. In certain applications, especially oil field usage, the operating environment can be severe. Mechanical chart recorders are exposed to extreme temperatures, with wide temperature fluctuations, as well as humidity, precipitation and the constant vibration of the pumping unit.

Although prior art mechanical chart recorders provide operators with a generally trouble-free and low maintenance device for logging important data, if a failure occurs the prior art does not provide a means for recovering lost data. In certain applications, most notably oil field usage, the operating environment can be severe. Mechanical chart recorders are exposed to extreme temperatures and temperature variations, moisture, precipitation, exposure to corrosives (saline reservoir water and salt spray) and the continual vibration generated by the pumping action of the rod pump. However, probably the most unreliable factor in the use of chart recorders in oil field applications is the operator.

Any chart recorder (mechanical or otherwise) must be serviced at regular intervals. The length of the service interval is determined by the clockworks selected for driving the chart. The clockworks selected for the recorder establishes the “rotations,” or the time that chart takes to turn one complete revolution (popular clockworks rotations for oil field use are one, two, seven and eight day rotations), hence the sampling rate of the data is subject to the selection of the clockworks. Usually, more important wells, i.e., those producing at higher rates, are sampled more frequently (one or two day rotations). Less profitable well, those with lower production rates, are usually sampled less frequently (seven or eight day rotations) and require a corresponding less attention by the operator. Consequently, the charts must be replaced and the clockworks wound prior to the end of the rotation cycle to ensure a continuous and uninterrupted record log. Because mechanical chart recorders require regular service by an operator, the integrity of the data depends on the availability of an operator, as well as the proper operation of the recorder itself. The added service time also increases the expense of well operations.

Reliance on an operator for routine maintenance and can be diminished somewhat by replacing the mechanical chart recorder with a data logger. Modern data loggers have many advantages over prior art mechanical chart records, i.e., less human interaction, monitoring and maintenance while simultaneously acquiring higher sampling rates. However, replacing legacy chart recorders with newer data recorders and/or electric chart recorders is relatively expensive and the well's production may not support the additional cost. More than 75 percent of all oil wells in the United States are classified as “stripper wells,” producing less than fifteen barrels per day and operate on razor-thin economics. Many of these wells rely on legacy chart recorders for their operation. Interestingly, of the over 400,000 stripper oil wells in the U.S., the cumulative production accounts for nearly one million barrels of oil per day. However, between 1993 to 2000, about 150,000 of these stripper wells were abandoned, most due to high operating expenses (Low Cost Well Monitoring Could Save Marginal Oil Wells, US Department of Energy, Wednesday, Jan. 19, 2005, available at rigzone.com/news/article.asp?a_id=19582, last accessed Apr. 4, 2006).

Upgrading to an electrical data logger and/or chart recorder necessarily includes upgrading all incompatible mechanical components from the mechanical system. For instance, the mechanical sensor elements used with a legacy recorder must also be upgraded with electrical sensor elements that are compatible with the particular type of electrical data logger chosen. Additionally, a suitable electrical supply source must also be secured, even if a battery powered unit is selected. Other expenses may also include power and power distribution equipment, data transmission equipment and transmission fees (landline telephone, cell, satellite, radio, pager, etc.). Furthermore, while reliance on the operator for monitoring may be reduced, it is not eliminated altogether. The operator must still provide preventive maintenance as required, e.g., recharge and/or replace batteries and recalibrate the recorder and/or sensor elements as necessary, as well as download data from the recorder (assuming a non-transmitting type is employed) and generally be available to service the unit after a failure. Each add expense to the total cost of ownership of an electrical data logger and/or chart recorder.

What is needed is a means for providing legacy mechanical chart recorders with the advantages of more modern data loggers without incurring the expense of replacement with a modern data logger. Additionally, it would be useful to attain these advantages without interfering with the logging operation and/or mechanical movements of motional members of the mechanical chart recorder, thereby simultaneously logging data electronically and to the paper chart record.

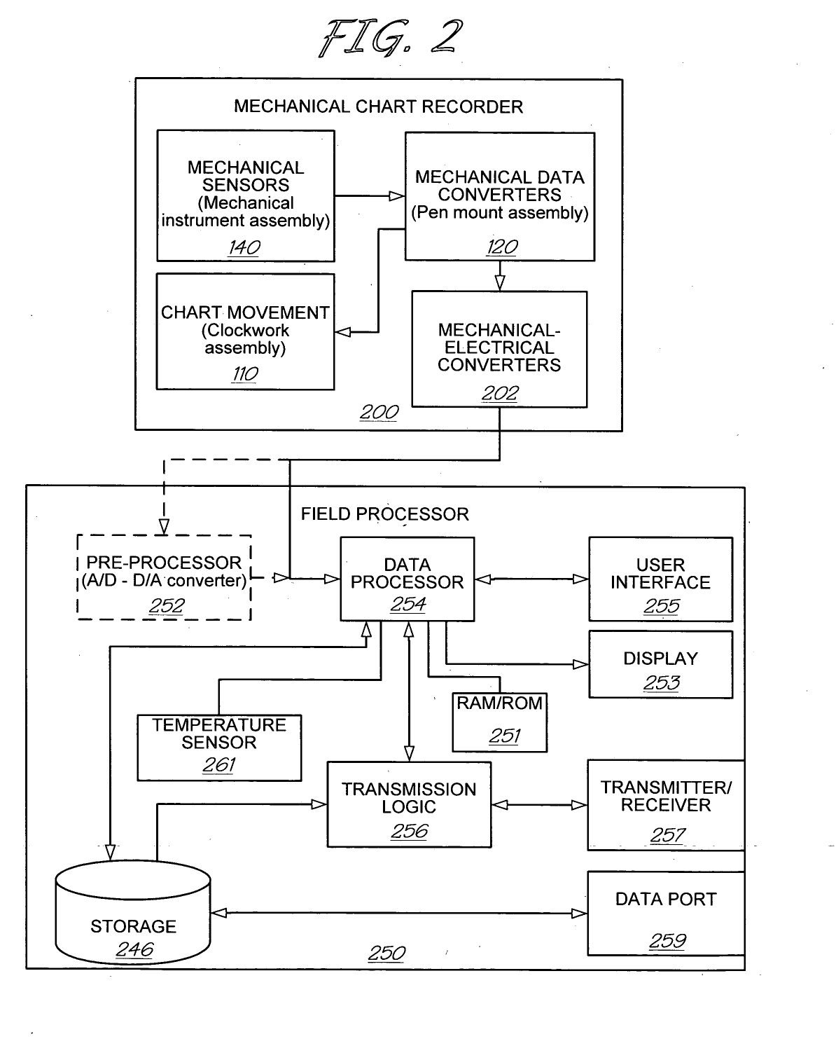

FIG. 2 is a diagram of the logical elements for reconfiguring a legacy recorder to operate as a data logger using a mimic gauge in accordance with one exemplary embodiment of the present invention. The present chart recorder 200 generally comprises mechanical sensors (mechanical instrument assembly) 140, mechanical data converters (pen mount assembly) 120 and chart movement (clockwork assembly) 110, generally as described by chart recorder 100 in FIGS. 1A and 1B above. However, chart recorder 200 includes a mimic gauge that generally comprises mechanical electrical converter 202 for converting the mechanical movement that is available from a legacy chart recorder to an electrical signal of the measurement that may be handled similarly to conventional data loggers. Optionally, the mimic gauge may include some or all functionality of field processor 250, which may be provided for handling the converted electrical signals in accordance with another exemplary embodiment of the present invention. As a practical matter, field processor 250 may be configured from a general purpose computer, but also may be a special purpose data processor especially designed for oilfield use, for instance the ST2500 field processor available from Stellar Satellite Communications Ltd. of Dulles, Va. or the field processors are available from Skywave Mobile Communications Inc. of Ottawa, Ontario, Canada.

Typically however, in order to reduce expense and limit the exposure to a potential loss of the unit, field processor 250 is configured as a dedicated electronics unit intended for performing specific data logging functions without peripheral support. Moreover, most of the functions of field processor 250, discussed immediately below, may be included in onboard elements of mechanical electrical converter 202. Field processor 250 is capable of linking to a laptop PC or other portable computing device for performing tasks that require additional peripheral support, e.g., user interface, display device, etc. Moreover, in accordance with other exemplary embodiments of the present invention the data handling capabilities may be provided onboard enclosure 102 of chart recorder 200, using only an external data port to calibrate mechanical electrical converters 202 and access the measurement data stored therein.

The function of field processor 250 is to provide electrical power to mechanical-to-electrical converter 202 (not specifically shown in the figure) and process data signals generated by mechanical-to-electrical converter 202. It should be understood that although the exemplary embodiments are described as having mechanical-to-electrical converter 202 generating a purely electrical position signal, it should also be appreciated that the signal may take the form on an electromagnetic position signal, such as a light position signal. Particular mechanical electrical converters 202 may produce analog or digital signals depending on their respective capabilities. Additionally, data processor 254 of field processor 250 may be compatible with an analog signal or digital signal or both. Therefore, field processor 250 may include an analog to digital (A/D) converter 252 and/or a digital to analog (D/A) converter 252 for pre-processing the raw data signals from mechanical electrical converter 202. It should, of course, be appreciated that the amount of processing external to the particular mechanical electrical converter will depend on the sophistication of the converter. Some, more complex converters may have the native ability to communicate with an interface, receive calibration instructions and/or input parameter data, and then process the data signal internally (for those situations data processor 254 and pre-processor 252 are logically included within mechanical electrical converter 202).

In any case, data processor 254 provides the functionality and processing capability to filter noise from the incoming data signals and then convert the raw data signals into calibrated data signals that correlate to the measurement data (noise filtering may also be performed external to field processor 250). Data processor 254 may have an internal nonvolatile memory (ROM 251) for storing smoothing algorithms, calibration algorithms; user defined input parameter data and/or calibration data. Signal processor 254 is coupled to user interface 255, for receiving commands and user input parameter data, and further coupled to optional display 253 for verifying commands and viewing system responses and sensor element readings in real-time. On board display 253 is limited to a few LCD or LED lines, however the trend has been toward including an LCD screen, or touch screen. Signal processor 254 is also coupled to storage 256 for storing signal data, software programs and user defined parameter values for the software applications. Optionally, Both the raw data and processed measurement data may be stored simultaneously, i.e., the unprocessed data from mechanical electrical converter 202 (or pre-processor 252), as well as the processed data from data processor 254). Storage capacity is also available in one of storage 256 and RAM/ROM 251 for storing application code and routines to be called up and executed by data processor 254. Additionally, RAM/ROM 251 may be utilized as a buffer or cache for temporarily storing data and/or program instructions. Field processor 250 may also include temperature sensor 261 for monitoring the ambient temperature of the electronics.

Once processed, the data signals may be stored in onboard storage 256 or transmitted to a remote location in real-time using transmission logic 258 over transmitter/receiver 257. Additionally, the signal data may be cached in storage 256 until a preset time or until receiving a transmission request via receiver 257. In that case, the signal data are retrieved from onboard memory 248, packaged for transmission using transmission logic 258 and then transmitted over transmitter/receiver 257. It is expected that transmission logic 258 and transmitter/receiver 257 are under the control of data processor 254 or higher level capabilities in transmission logic 258. Transmission logic 258 and transmitter/receiver 257 may facilitate wired or wireless transmission over public switched telephone network (PSTN), cell network, fiber network, Ethernet network, dedicated radio and/or microwave channel, using one of exemplary PSTN signaling system seven (SS7) protocol, wavelength division multiplexing (WDM), simple network paging protocol (SNPP) or wireless communications transfer protocol (WCTP), using transmission control protocol (TCP) and Internet protocol (IP) or TCP/IP and others. Transmissions may be terrestrial or via satellite, either low earth orbit LEO (low earth orbit) or geosynchronous. The transmission of data may be in real-time as it is received from mechanical electrical converter 202 or may be delayed until a preset transmission time, or may still be called-up remotely at a convenient time. Given the sensitive nature of the data, it should be encrypted prior to transmission over any unsecured network. One exemplary field process which enables communications with LEO satellites is an ST2500 available from Stellar Satellite Communications Ltd. of Dulles, Va. and for communications with geosynchronous satellites; field processors are available from Skywave Mobile Communications Inc. of Ottawa, Ontario, Canada.

The primary function of mechanical electrical converter 202 is to convert the existing mechanical motion corresponding to the measurement information, into to electrical signals that are suitable for storage or transmission. However, most mechanical sensor elements are designed to produce only enough of mechanical force to drive the recorder, i.e., to move the sensor drive linkage. Therefore, another feature is that mechanical-to-electrical converter 202 does not inhibit the free rotation of pen arm 130 across the entire range.

In accordance with one exemplary embodiment of the present invention, mechanical electrical converter 202 employs an off-the-shelf (OTS) sensor element that is commercially available for converting a mechanical measurement reading to an electrical signal that is representative of the mechanical reading. At the heart of the converter is a mechanical sensor element that senses changes in the position of one or more components in the sensor-to-pen drive linkage of the chart recorder, for instance the element drive link 146, sensor drive link 136, range arm 132, pen arm shaft 130 and/or pen arm 122. It should be recognized, however, that OTS components come in a variety of quality grades. Typically, higher quality grade sensors exhibit higher accuracy, resolution, linearity, traceability, stability and repeatability, but at a higher cost. Most of the sensors described subsequently below, are available in a scientific grade, which is generally characterized as having higher accuracy, better linear, and stable over a wide range of ambient temperatures. However, scientific precision is not necessary for many of the applications described and the cost of these sensors is often prohibitive. One option is using a sensor of midrange quality. Typically, the accuracy of these sensors surpass any criteria necessary for oil field use and are relatively linear, but often have temperature related stability issues. Usually the manufacturers of these devices provide temperature correction charts that can be used for temperature correcting the output signals. These tables can be loaded into storage 256 for use by data processor 254 in temperature correcting the calibrated measurement values (as will be described below, the raw sensor reading obtained from mechanical electrical converter 202 are converted to calibrated measurement values that represent the output of mechanical instrument 140).

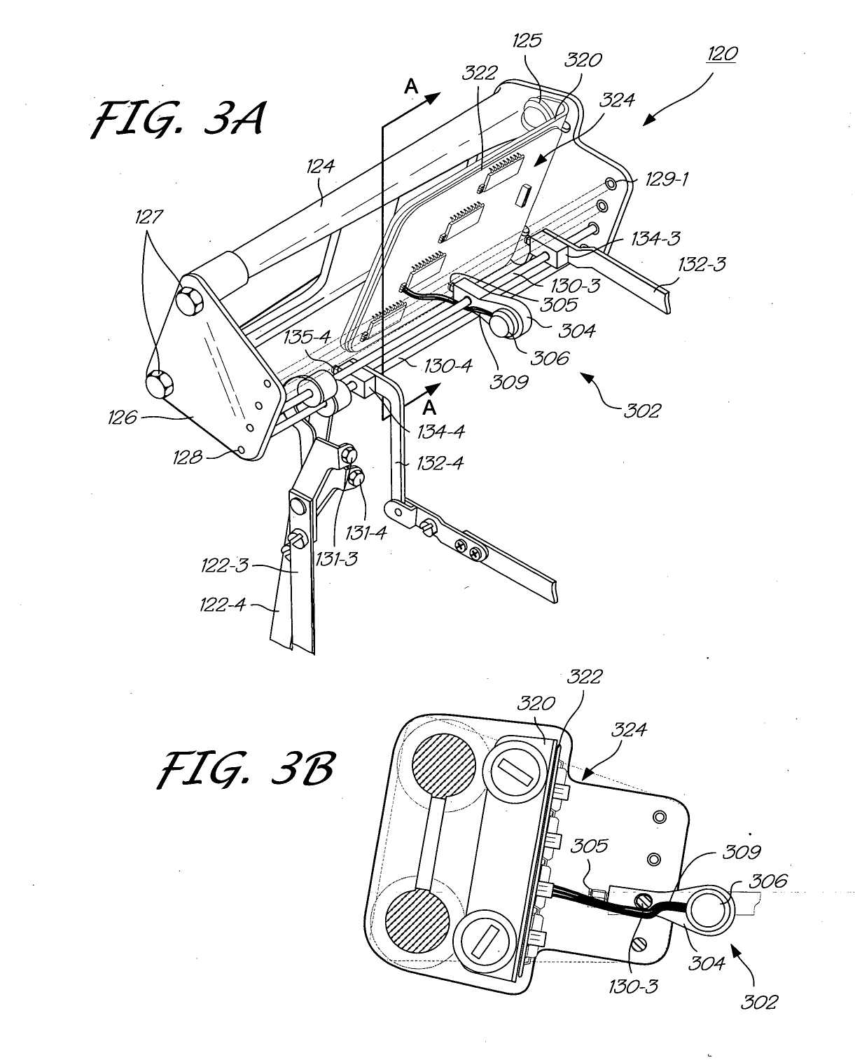

FIGS. 3A and 3B are diagrams of an exemplary mechanical chart recorder after conversion for generating electrical signals in accordance with an exemplary embodiment of the present invention. FIG. 3A is an oblique view of the internal mechanical section that controls the stylus movements, including a mechanical-to-electrical converter. FIG. 3B is a cross-sectional side view of the pen mount assembly at section line AA, including the mechanical-to-electrical converter on a pen arm shaft. Here, pen mount assembly 120 includes one or more mechanical-to-electrical converters for monitoring the spatial position of one of the moving elements on pen mount assembly 120 or mechanical instrument assembly 140, depicted in the figure as inclinometer assembly 302 (although only a single inclinometer assembly is depicted in the present figure, one assembly may be disposed on each pen arm shaft installed in the recorder). The purpose of the present mechanical-to-electrical converter is to convert spatial movement into more convenient electrical data signals that can be transmitted or stored, hence the mechanical output of mechanical instrument assembly 140 can be simultaneously recorded as a chart log and as an electronic log.

Inclinometer assembly 302 generally comprises inclinometer 306, which is secured to sensor table/shaft lock 304 using shaft locking screw 305. Inclinometer 306 may be any commercially available inclinometer that is relatively stable, and linear, over a wide temperature range and having a dynamic range of >45° (which correlates to the maximum rotation of the pen arm shaft (45°)) with resolution of at least that of the corresponding mechanical sensor. For instance, if a temperature sensor is capable of 0.2° C. resolution across a range of 100° C., then the inclinometer sensor should have a threshold resolution of approximately 0.06° of inclination. An exemplary inclinometer having a resolution of 0.02° is the H5 Series available from Rieker Electronics, Inc. of Folocroft, Pa. It should be understood that rather than using a self-contained inclinometer package as depicted in the figures, the inclinometer may instead be bare IC chip mounted on a circuit board with any other electronic components that may be necessary, such as the SCA103T-D04 chip from VTI Technologies Dearborne, Mich.

Essentially, inclinometer assembly 302 is adjustably fastened to pen arm shaft 130 in the same manner as range and pen arms in the prior art recorders as discussed above. The converter sensor of the present invention may be employed for monitoring the position of any component in the sensor to pen linkage in a chart recorder, but monitoring the movement of the pen arm shaft greatly simplifies the installation. Since each mechanical sensor element is physically unique, the arrangement and positioning of sensor elements depends on the physical characteristics of the elements and the available space in the enclosure 102, and so then would the installation of a position sensor.

The movement measurements in inclinometer assembly 302 are made by inclinometer 306 which is oriented perpendicular to a plane aligned with the rotational axis of rotation, as depicted in the example, inclinometer 306 is oriented in a horizontal plane that is substantially perpendicular to plane in which pen drive shaft 130 lies (depicted herein affixed to sensor table/shaft lock 304). Inclinometer wiring 309 couples inclinometer 306 to external field processor 250, or, and as shown in the figure, to optional electronic components 324 mounted on circuit board 322, for transmitting the electrical position signals therebetween. Notice that circuit board 322 is secured to pen mount body 124 by means of optional adapter flange 320. Adapter flange 320 provides a stable platform for securing nonmoving part of the mechanical-to-electrical converter, as will be apparent from the discussion below. Adapter flange 320 is merely representative of an easily installed mounting surface for components of the present invention, but by no means the only alternative for mounting electronics or securing other components internally in the recorder enclosure.

One advantage in using the particular configuration of adapter flange 320 depicted in the figure, with exemplary chart recorder 100 is the ease of installation. Here, the operator need merely detach pen mount shaft cap 126 by loosening cap retaining screws 127 (leaving the pen arm shafts in place with the sensor drive links) and then loosening pen mount body screws 125 enough to slide adapter flange 320 between the washers and pen mount body 124. Adapter flange 320 is provided with a pair of slots for receiving the shafts of pen mount body screws 125. After pen mount body screws 125 are tightened, inclinometer assembly 302 is placed on a pen arm shaft, pen arm shaft 130-3 as depicted in the figure. Depending on how the linkage for the particular pen arm shaft is configured, it might be necessary to temporarily remove one or both of pen arm 130 and range arm 132 to fit inclinometer assembly 302 on pen arm shaft 130. While positioning inclinometer assembly 302 along pen arm shaft 130, the positions of other inclinometer assemblies, range arms and pen arms on pen mount assembly 120 should be considered. Inclinometer assembly 302 should be secured at a location along the pen arm shaft that will not interfere with the operation of any other component or come in contact with another pen arm shaft. The inclinometer assembly should be oriented approximately horizontal, or slightly lower, to correspond with the mid-range position of the corresponding pen on the chart. This ensures that inclinometer 306 can rotate freely across the azimuthal range corresponding to the chart range. Some minor adjustment may be necessary after pen mount shaft cap 126 has been replaced.

With regard to the present exemplary embodiment, inclination signals are generated by inclinometer 306 that correlate to log parameter values read by the mechanical sensor element. One advantage of using an inclinometer is that the entire inclinometer assembly can be secured to pen arm shaft 130, thereby eliminating the need for adapter flange 320. Other converter sensors determine movement relative to a fixed point, thus a stable platform, such as adapter flange 320, should be availability.

Regardless of which type of converter sensor is selected for use in tracking the position of the pen arm, the position signals generated by that sensor should be calibrated to known values of the log parameters. This is accomplished by adjusting readings from the converter sensor to the position of stylus 121 on chart record 118 (recall that the stylus 121 records calibrated record of readings from a particular sensor element on chart 118). Alternatively, readings from the converter sensor may be directly calibrated using readings from the mechanical sensor element.

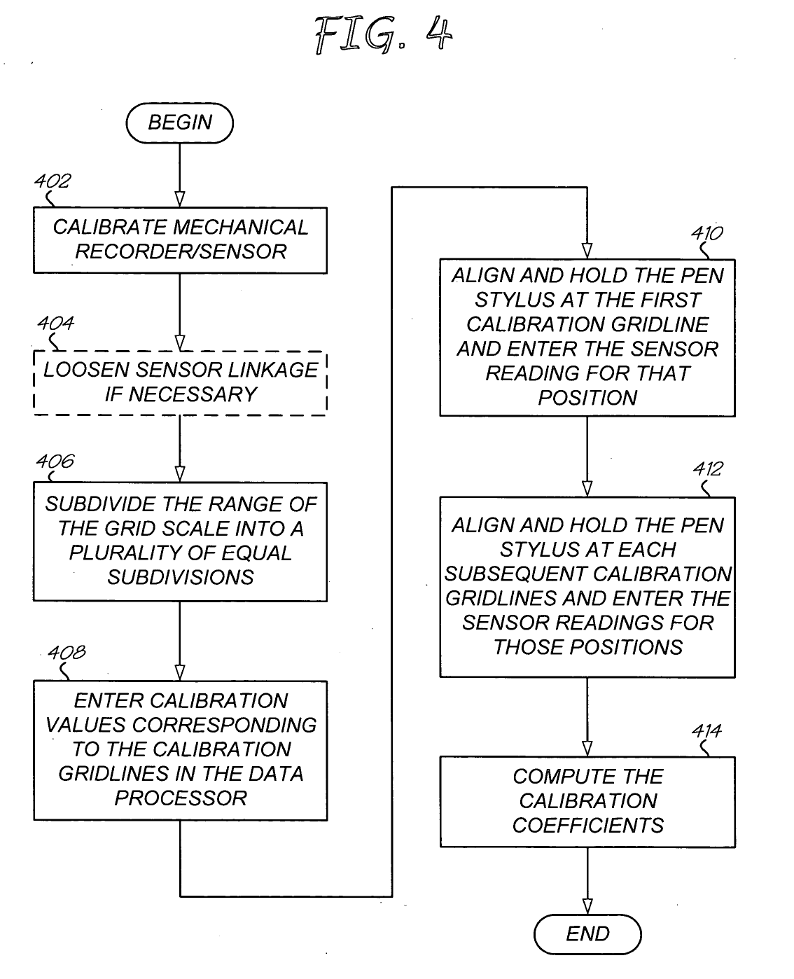

FIG. 4 is a flowchart illustrating a method for calibrating a mechanical sensor element in a mechanical-to-electrical converter, configured in a mechanical chart recorder, using the stylus position on the chart record in accordance with an exemplary embodiment of the present invention. The mechanical-to-electrical converter is secured to pen mount assembly 120 (or some other moving part in the mechanical linkage between the sensor and stylus) as described immediately above. With inclinometer assembly 302 (the position sensor) secured to pen mount assembly 120 (or some other moving part in the mechanical linkage between the sensor and stylus), the raw inclination signals generated by inclinometer 306 are calibrated relative to the actual position of the pen stylus 121 on the chart 118. The calibration gridlines represent the parametric values for the particular sensor, e.g., temperatures, pressures, depth readings, etc. Therefore, before using this calibration technique, the mechanical sensor element should be calibrated on the mechanical recorder as per the instructions from the manufacturer (or the sensor's manufacturer) (step 402). If the movement of the particular sensing element is stiff, that is it rigidly holds the pen arm in place such that moving the pen arm might damage the pen arm or linkage, the range arm 134 should be loosen on pen arm shaft 103 (or a connection in the linkage to the sensor uncoupled) to allow the pen and pen shaft to move freely (step 404). Loosening the range arm 134 will not affect the inclinometer readings because the inclinometer is not physically connected between the range arm 134 and sensor element. Essentially, the inclination readings of the pen arm shaft are taken with the pen aligned to a predetermined number of calibration gridlines on chart record 118. Using these calibration points, the inclinometer readings can be mapped to all of the gridlines on the chart, and hence all log parameter values, by calculating the calibration coefficients for a standard slope-intercept algorithm, such as y=mx+b, and applying the slope-intercept algorithm to the raw inclination data.

Calibration of the inclinometer signal generally proceeds as follows. The grid range is subdivided into equal divisions for that define the calibration values (step 406). If the position sensor of the mechanical-to-electrical converted is completely linear, one two calibration points are necessary, a 0 point and a full scale, or range point). It is expected that most sensors exhibit some amount of nonlinearity; this nonlinearity can be accommodated for by calibrating the sensor to multiple, evenly spaced calibration points on the chart. For instance, if the grid scale of a chart is 0 to 1000, ten calibration intervals would be every 100 gridlines, 0, 100, 200 and so on (five calibration intervals would be every 200 gridlines). Manually enter the parametric measurement values associated with the calibration gridlines into data processor 254 using user interface 255 (step 408). For instance, each gridline may represent 0.1 PSI with full scale being 100 PSI; in that case the eleven calibration measurement values points: 0 PSI, 10 PSI, 20 PSI, 30 PSI, 40 PSI, 50 PSI, 60 PSI, 70 PSI, 80 PSI, 90 PSI and 100 PSI. Then, manually align stylus 121 over the first calibration gridline on chart record 118 (the 0th gridline) which causes pen arm shaft 130 to rotate slightly (step 410). If the mechanical sensor has not been disconnected, the pen arm must be manually held in position. The inclinometer tracks the inclination angle of pen arm shaft 130 as it rotates with the movement of pen arm 122 and the inclinometer reading can be monitored on display 253. Accept the inclination of pen arm shaft as taken from inclinometer 302 using user interface 255.

Next, stylus 121 is aligned over the second calibration grid line (the 100 grid line) and the new reading from inclinometer 302 is accepted in data processor 254 using user interface 255 (step 412). The calibration procedure continues as described above for the 100 and 200 grid lines, the 200 and 300 grid lines, and so on up to the 1000 grid lines. Data processor 254 then calculates the slopes and intercepts between each pair of calibration values. In so doing, all raw inclination angles received from the inclinometer can be mapped to corresponding chart grids using the appropriate slope-intercept algorithm derived for each pair of calibration points. Chart record 118 and pen stylus 121 can then be removed from chart recorder 100 if only the electronic measure data is desired.

An automated routine may be available in a memory of field processor 250 that can be called up by an operator to setup, calibrate and log any of the various mechanical-to-electrical converters installed on a particular recorder. The routine guides the operator through the setup and calibration phases and for automatically determining calibration coefficients for a particular converter sensor and then implements the calibration coefficients in a correction algorithm for creating log data by adjusting the raw data from the converter sensor. The routine interactively displays screen data with entry fields for inputting calibration data and display fields for monitoring readings from the converter sensors throughout the calibration process. The routine may be subdivided into a logical series of sequential tasks, e.g., setup, calibrate and log phases. In the setup phase the operator enters the calibration values used with a particular measurement. In the calibrate phase the calibration readings from the converter sensor are accepted for the various calibration points and then data processor 254 calculates calibration coefficients from the user-entered calibration data and the readings from the converter sensor. In the log phase, data processor 254 applies a correction algorithm, with the calibration coefficients, to the raw movement data generated by the converter sensor. In practice the operator merely follows the screen prompts for setting up the converter sensor and calibrating the sensor to a known parameter value, e.g., the inclinometer signals to gridlines on the chart record.

Alternatively, the inclinometer signal can be calibrated directly from the mechanical sensor itself. Using the sensor manufacturer's directions, rather than calibrating the zero and range points on chart record 118, the zero and range calibration values are selected based on the particular mechanical sensor being calibrated. For instance, certain pressure sensors may be calibrated using two known pressure values and two corresponding raw measurement readings from the particular sensor (i.e., by using a manual pressure pump to artificially increase the pressure to the sensor to known pressure values read from a calibrated pressure gauge). These values are used to determine the calibration coefficients (i.e., determine the slope and intercept for y=mx+b). For example, a pressure sensor may be calibrated using the two known values of atmospheric pressure (0 psig) and the current line pressure on tube 143 (x psig), which may be the working pressure of the source or an artificial pressure induced by manually using a pump. The calibration then proceeds as follows. The pressure on tube 143 is measured using a suitable line gauge connected to the input of tube 143 (not shown). That pressure is manually entered into data processor 254 using user interface 255 and verified by monitoring display 253 (it is assumed that 0 psig is used for the zero calibration, so if another pressure value is available, it must also be manually entered). Next, the reading from inclinometer 302 is obtained (and verified on the display) as the current pressure (x psig) and accepted in data processor 254 using user interface 255. Next, the pressure on tube 143 is bled off for obtaining the zero measurement reading, which results in an equivalent reading of 0 psig on the inclinometer. The zero reading of inclinometer 302 is then accepted in data processor 254 using user interface 255. Data processor 254 then calculates the slope and intercept between the pair of calibration values and raw inclination angles received from the inclinometer and can be mapped to corresponding measurement values. In the example above, pressure measurement values are described, however, the calibration techniques described herein and above are applicable to any other measurement value, e.g., temperature, flow rate, pump rate, fluid level, etc. If a pump is being used to generate the calibration pressures, intermediate pressure values between the zero and line pressure calibrate measurement readings can then verified with the position of the stylus 121 on chart record 118 for linearity, if the chart measurement readings varies from the gauge measurement readings those differences should be noted, however because most mechanical chart recorders are calibrated on the basis of two calibration points, any non-linearity identified from the intermediate pressure measurement reading cannot be compensated out through calibration.

In log operation, data processor 254 produces a calibrated stream of measurement data using the calibration coefficient derived immediately above. This electronic data corresponds to the log data recorded on chart recorder 118. As mentioned above, electronic log data may be saved for a future download, transmitted to a remote location in real-time or some combination of the two. As should be apparent, the presence and operation of inclinometer assembly 302 will not compromise the accuracy of the readings on chart recorder because the inclinometer does not inhibit the movement of the pen arm shaft to which it is attached. Furthermore, the sampling rates attainable from use of the present invention are much higher than the resolution of a prior art chart recorder. Most sensors described herein have the capability of sampling several hundred readings per second. However, for oil field uses, especially wellhead, pipeline and tank applications, this is simply too much data retention. Therefore, a sampling rate for each sensor used with the recorder may be selected. Higher sample rates results in more log data and that enables the operator to more fully analyze log events, such at those that appear as spurious noise on a chart recorder, but may actually have some other significance. Additionally, rather than merely recording a single sample during the specified time interval, the measurement data are cached in RAM/ROM 251 by data processor 254 over a time interval and then averaged over that interval according to an averaging algorithm (such as a simple average or Gaussian equation). Using an averaging algorithm will reduce the likelihood that single sample contains only spurious noise (if noise occurs during the sample interval its affect on the sample is lessened by the averaging).

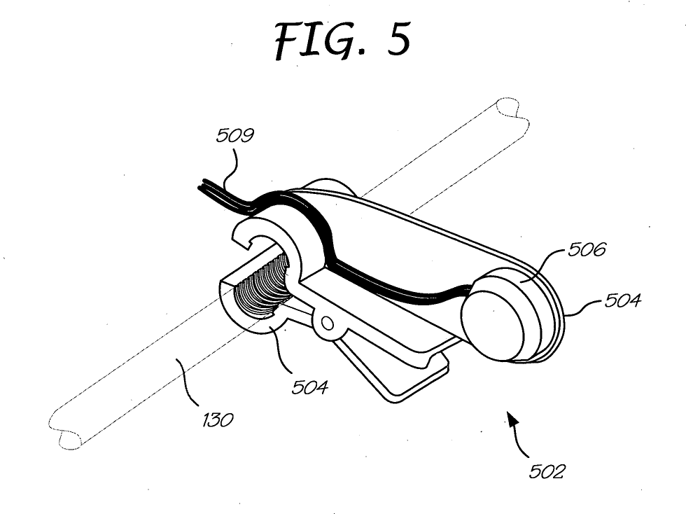

FIG. 5 is an enlarged diagram of a mechanical-to-electrical converter for measuring the inclination angle of the pen arm shaft that utilizes a clamshell shaft connection in accordance with an exemplary embodiment of the present invention. Here, mechanical-to-electrical converter 520 includes inclinometer 506 mounted on sensor table 504, as discussed previously. However, rather than having a clampblock shaft connection for connected to pen arm shaft 130, an articulable clamshell shaft connection is disposed thereon. The clamshell connection allows the operated to attach multiple converter sensors on pen arms 130 without having to disassemble pen mount assembly 120 to slip on the clampblock shaft connections. Furthermore, since inclinometers accurately determine angular position without the need of stable reference position, adapter flange 320 is likewise unneeded. Inclinometer wiring is merely router to a waterproof connection socket for coupling to field processor 250.

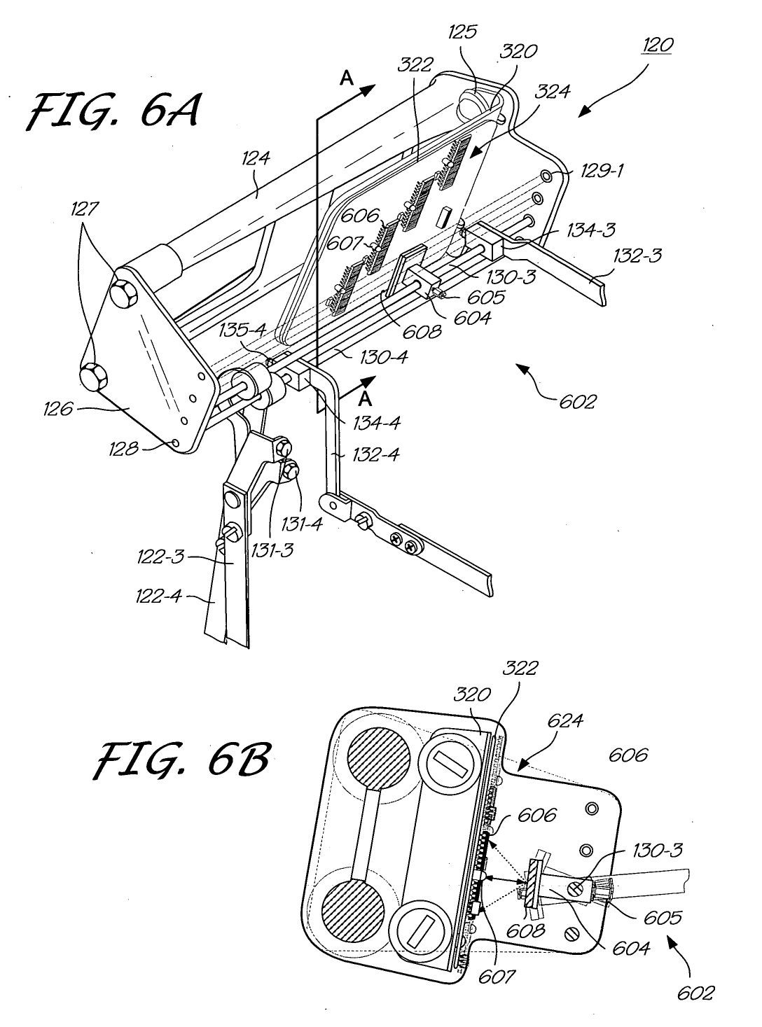

FIGS. 6A and 6B are diagrams of a mechanical chart recorder utilizing an optical converter sensor for monitoring the angular position of the pen arm shaft in accordance with an exemplary embodiment of the present invention. FIG. 6A is an oblique view of the internal mechanical structure of recorder 200 and FIG. 6B is a cross-sectional side view of the pen mount assembly at section line AA, including optical converter assembly 602. Optical converter assembly 602 includes stationary light source 607, electronic light sensor 606 (a CCD (charged coupled device) or similar photoelectric sensor) and mirror 608 affixed to pen arm shaft 130. Convention CCDs are small arrays of photoelectric that respond to light. 1024×1 cell arrays use 1024 separate cells for determining the position of the reflected light on the CCD (yielding an uncorrected resolution of=0.03°, a higher effective resolution is possible from this chip using an linear interpolation algorithm). 1024×1 arrays are common and relatively inexpensive, such as the CCD133 model available from Fairchild Imaging in Milpitas, Calif. Light source 607, electronic light sensor 606 and other sensor electronic are prefabricated on circuit board 324, which is electrically isolated and mounted to pen mount assembly 120. Stationary light source 607 is typically an LED (light emitting diode) contained within a focusing lens for directed the light as a narrow beam. Mirror 608 creates a dynamic light path from light source 607 to electronic light sensor 606 that changes position on sensor 606 in response to an angular displacement of pen shaft 130. As depicted in the exemplary embodiment, mirror 608 is secured to shaft 103 with mirror table/shaft lock 604; however a clamshell connection may also be employed.

FIGS. 7A and 7B are diagrams of yet another type of converter sensor in a mechanical chart recorder, this type measures changes in linear position in accordance with an exemplary embodiment of the present invention. FIG. 7A is ad oblique view of the internal mechanical structure of recorder 200 and FIG. 7B is a cross-sectional side view of the pen mount assembly at section line AA, including linear position sensor assembly 702. This type of device senses linear displacement between two points, therefore linear position sensor assembly 702 requires a stationary mounting surface for making measurements. As depicted in the figure, sensor range arm 708 is fitted to pen shaft 130 with a circular shaft clamp and secured by sensor shaft lock screw 705. Sensor shaft 703 is pivotally connected to the distal end of sensor range arm 708, near one end, and to linear position sensor 706 toward the second end. Functionally, linear position sensor 706 may be a potentiometic or magnetostrictic. Potentiometic sensors usually have a slide mechanism for moving a contact along a linear pot which changes the resistivity in the sensor proportional to the position of the slide (as depicted in the figure). Magnetostrictic sensors convert magnetism to kinetic energy and therefore do not need a physical connection between the magnet and the magnetostrictic sensor, however in this case the slide mechanism moves the magnet along the magnetostrictic sensor. Another type of magnetic position sense uses anisotropic magneto-mesistive (AMR) sensors for implementing a non-contact location of motional objects, such as HMC1501/HMC1512 linear/angular/rotary displacement sensors available from Honeywell International Inc. of Morristown, N.J. To avoid nonlinearity, the angle formed between sensor shaft 703 and sensor range arm 708 should approximate a right angle.

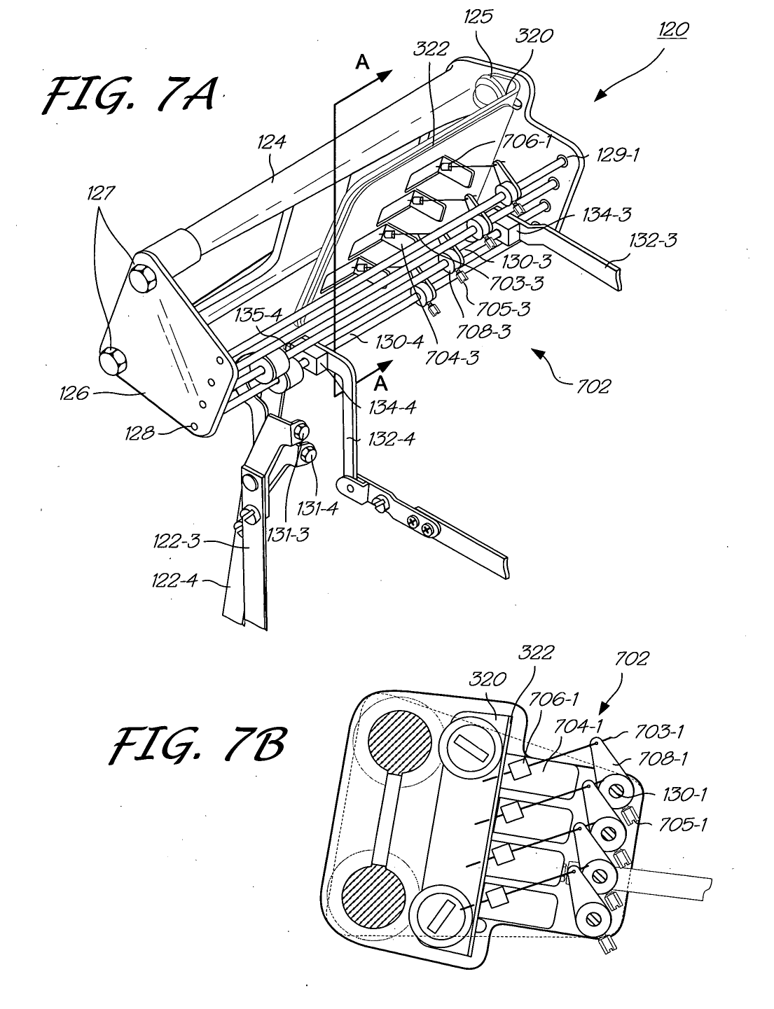

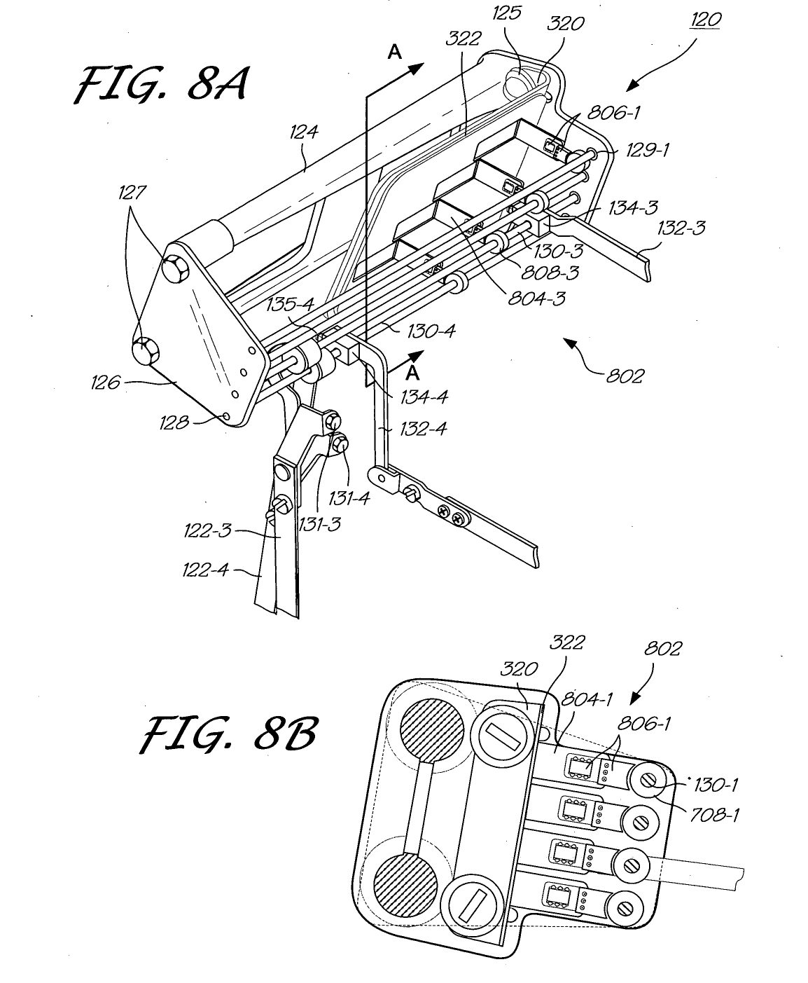

FIGS. 8A and 8B are diagrams of the chart recorder described above in which the converter's sensor measures changes in angular position in accordance with an exemplary embodiment of the present invention. FIG. 8A is an oblique view of the internal mechanical structure of recorder 200 and FIG. 8B is a cross-sectional side view of the pen mount assembly at section line AA, including angular position sensor assembly 802. Similar to the linear sensor discussed immediately above, this senses an angular displacement between two points and requires a stationary mounting surface for making measurements. As depicted in the figure, sensor magnet 808 is fitted to pen shaft 130 and secured. Angular position sensor 806 is positioned proximate to sensor magnet 808 and senses changes in the magnetic field when pen shaft 130 rotates. The angular sensor may also be a potentiometic sensor with an inner contact positioned along a circular pot and connected to a range arm. Force on the range arm causes it, and the inner contact, to rotate which changes the resistivity in the sensor proportional to the angular displacement (not shown).

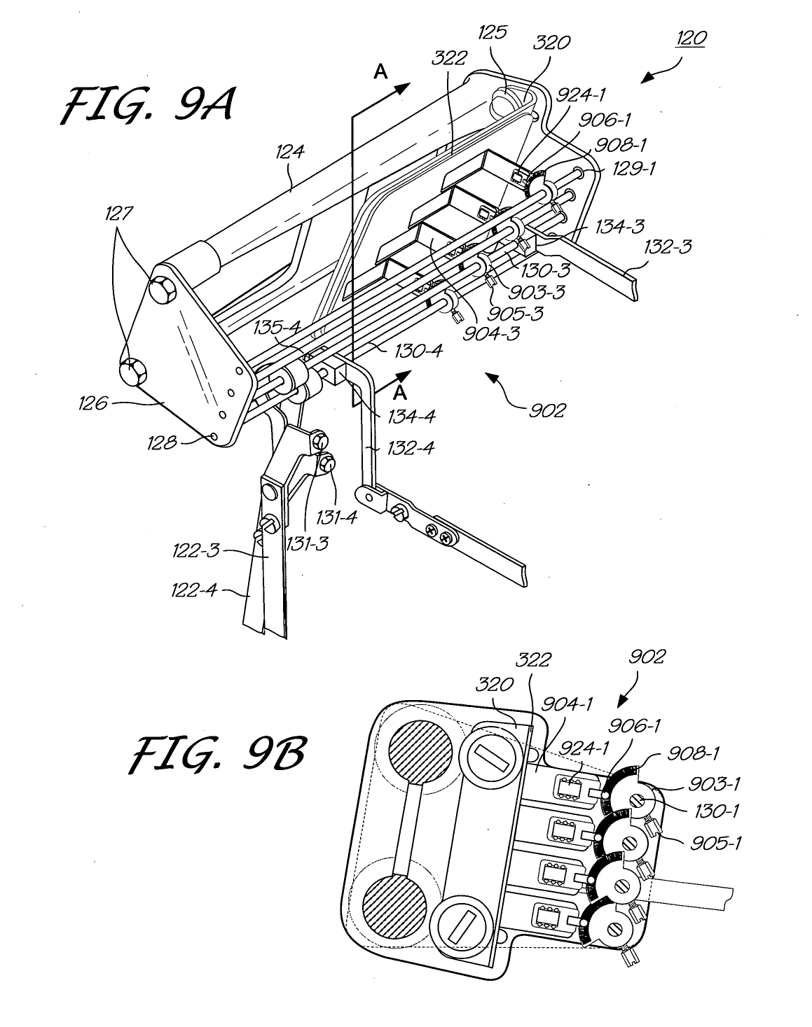

FIGS. 9A and 9B are diagrams of a non-contact type of converter sensor that measures changes in angular position in accordance with an exemplary embodiment of the present invention. FIG. 9A is an oblique view of the internal mechanical structure of recorder 200 and FIG. 9B is a cross-sectional side view of the pen mount assembly at section line AA, including an optical angular position sensor assembly 902. Optical angular position sensor assembly 902 uses light source/sensor 906 surrounding slotted target 908. Slotted target 908 is disposed on pen arm shaft by circular shaft clamp 903 and secured by sensor shaft set screw 905. As depicted in the figure, sensor source/sensor 906 and electronic 924 reside on sensor table 904 portion of adapter flange 320, via circuit board 322. A light beam is projected from the source side of light source/sensor 906, through slotted target 908 and is received at the sensor side of light source/sensor 906. As pen shaft 130 rotates, the slots change position and the light beam flashes through the spokes of target 908 and is perceived as movement by the sensor.

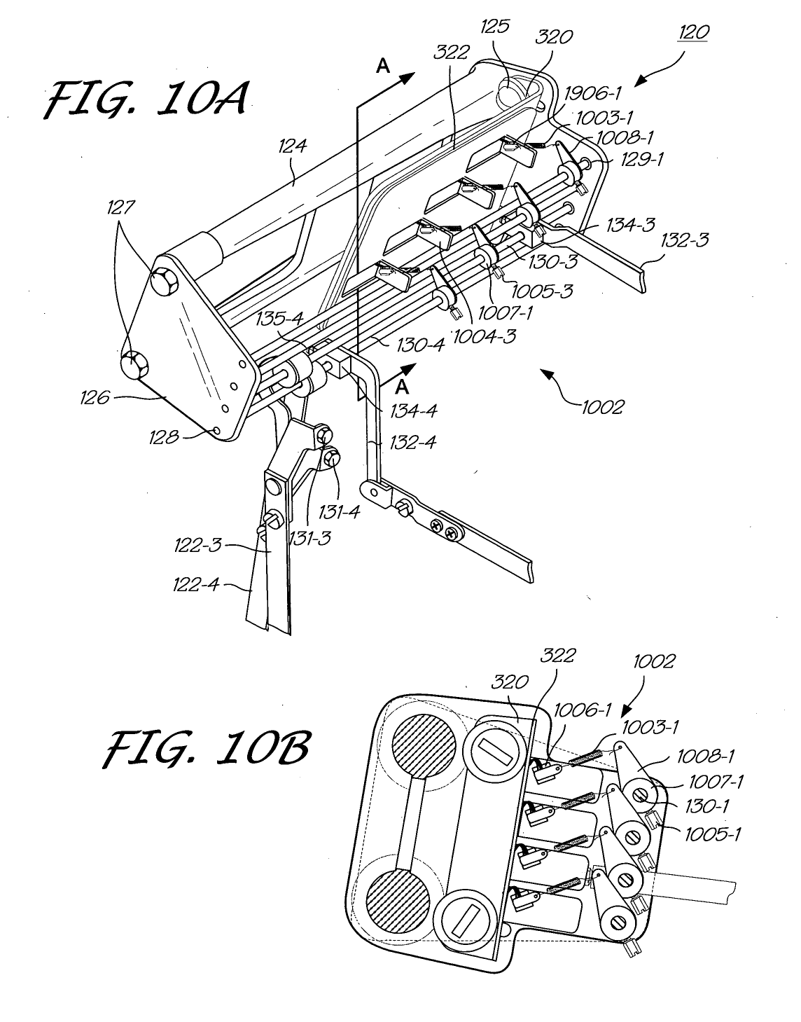

FIGS. 10A and 10B are diagrams of a converter sensor that measures changes in linear displacement using a strain gauge in accordance with another exemplary embodiment of the present invention. FIG. 10A is an oblique view of recorder 200 and FIG. 10B is a cross-sectional side view of the pen mount assembly at section line AA, including a strain-type angular position sensor assembly 1002. Strain-type angular position sensor assembly 1002 includes strain gauge sensor 1006 and auxiliary electronic 1024 residing together on sensor table 1004 portion of adapter flange 320, via circuit board 322. Sensor range arm 1008 is fitted to pen shaft 130 with circular shaft clamp 1003 and secured by sensor shaft lock screw 1005. Spring 1003 is attached to the distal end of sensor range arm 1008 and to strain gauge position sensor 1006 at the second end. As pen shaft 130 rotates, tension in sensor 1006 changes from the tension due to spring 1003. Strain gauges are of two general types, foil and piezoresistive. Capacitive pressure sensors use a thin diaphragm, usually metal or metal-coated quartz, as one plate of a capacitor. Strain on the diaphragm causes the capacitance to change. Strain on a foil or semiconductor (piezoresistive) gauge causes the resistivity to change in the material. As should be apparent, strain on the rotation of pen arm 130 has the adverse affect of reducing the overall accuracy of the recorder. An alternative embodiment to that depicted in the figure is using a leaf spring disposed between the distal end of sensor range arm 1008 and, rather tan the strain gauge position sensor, adapter flanged 302. In this case, the strain gauge sensor, typically a foil type gauge, is affixed to the body of the leaf spring using an adhesive. Strain is produced as the leaf spring compresses and relaxes with the movement of sensor range arm 1008. Strain gauges are of two general types, foil and piezoresistive.

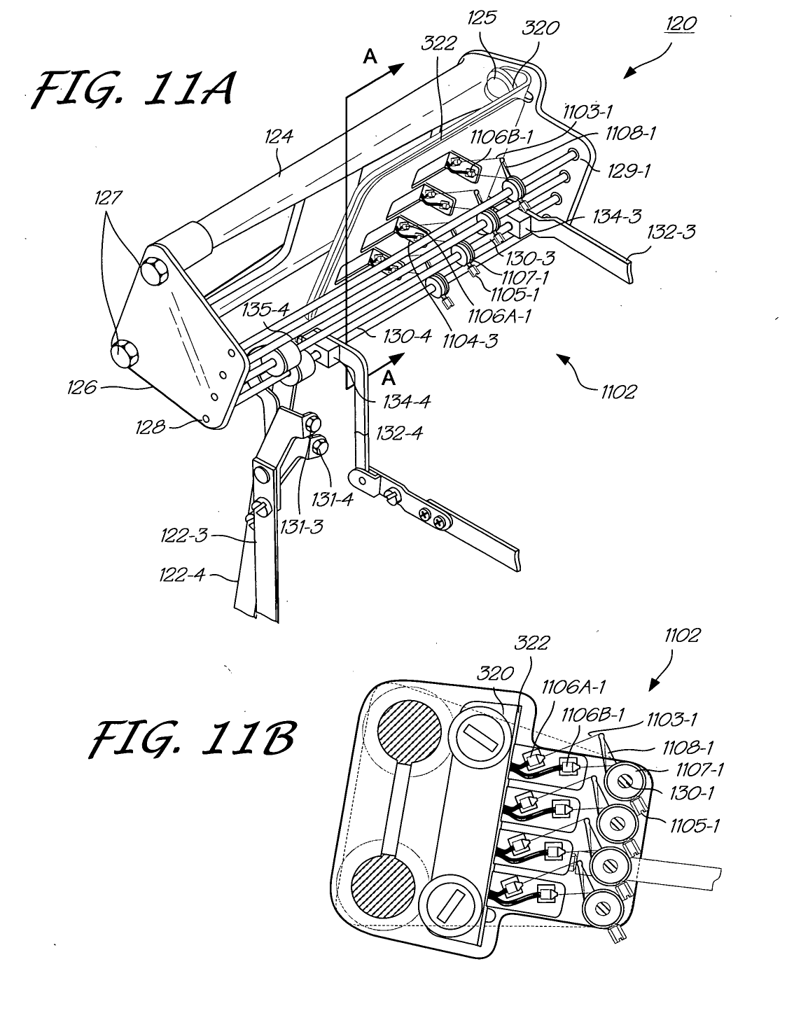

FIGS. 11A and 11B are diagrams of a converter sensor that measures changes in linear displacement using a special purpose strain gauge in accordance with another exemplary embodiment of the present invention. FIG. 11A is an oblique view of recorder 200 and FIG. 11B is a cross-sectional side view of the pen mount assembly at section line AA, including fiber optic strain sensor assembly 1102. Fiber optic strain sensor assembly 1102 includes optical transmitter/coupler 1106A, optical receiver/coupler 1106B and auxiliary electronic 1024 for processing the optical signals, both on circuit board 322. Sensor range arm 1108 is fitted to pen shaft 130 as discussed elsewhere above. Optical fiber 1103 is attached at one end to optical transmitter/coupler 1106A, wound around circular shaft clamp 1107, and egresses across the distal end of sensor range arm 1108 to receiver/coupler 1106B at the second end. As pen shaft 130 rotates, optical fiber 1103 turns around circular shaft clamp 1107 causing changes in the optical properties of optical fiber 1103 that are manifest as changes in a phase shift and signal attenuation. The phase shift and attenuation is measured by optical receiver/coupler 1106B and auxiliary electronic 1024 and relates to the position of pen arm 130.

The present invention has been described herein through the use of an exemplary mechanical circular chart recorder. Those of ordinary skill in the art will readily understand that the selection of the particular chart was based solely on describing the embodiment of present invention and is not intended to limit the application of the present invention or restrict is usage to only the exemplary chart recorder. It is contemplated that embodiments of the present invention are applicable of chart recorders other than those mechanically driven. Furthermore, those ordinarily skilled practitioners in the relevant art will recognize the applicability of the present invention to other types of chart recorders that operate a stylus by means of a rotating stylus shaft, or by utilizing the stylus itself. Moreover, and as will be appreciated by those practicing in the relevant technologies, the principles of the present inventions are adaptable to other types of chart recorders, such as roll format or strip format, that employ a rotating stylus shaft for causing a stylus pen to move across the chart.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or-limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

What is claimed is:

1. A mimic gauge for recording positions of a motional member in a chart recorder, comprising:
a mechanical-to-electrical converter for converting spatial positions of a motional member in a chart recorder into electrical signals related to the spatial positions, said mechanical-to-electrical converter comprising a spatial coupler for securing at least a portion of the mechanical-to-electrical converter to the motional member of the chart recorder, a position sensor for measuring spatial positions of the motional member and generating respective electrical position signals, and a signal connection for conveying the electrical position signals from the position sensor; and
a field processor electrically coupled to the mechanical-to-electrical converter comprising a data processor for transforming the electrical position signals into data representative of the spatial position of the motional member, and a memory.

2. The mimic gauge recited in claim 1, wherein the position member is a rotational shaft; said mechanical coupler further comprises:
a shaft grip for fastening to the rotational shaft, said shaft grip comprising a receiving member for cooperating with a surface of the rotational shaft and a biasing member for exerting a coupling force on the rotational shaft through the receiving member.

3. The mimic gauge recited in claim 2, wherein the biasing member comprises a threaded fastener and the receiving member includes a threaded orifice for receiving the threaded fastener.

4. The mimic gauge recited in claim 2, wherein the receiving member comprises a hinged grapple and the biasing member comprises an elastic body.

5. The mimic gauge recited in claim 1, wherein the motional member is a linkage, said linkage's spatial positions being along a generally linear path.

6. The mimic gauge recited in claim 5, wherein the position sensor is a linear position sensor for measuring spatial positions of the motional member along a generally linear path.

7. The mimic gauge recited in claim 5, wherein the linear position sensor further comprises a potentiometer.

8. The mimic gauge recited in claim 5, wherein the mechanical-to-electrical converter further comprises a magnetic field source generator secured to the mechanical coupler, and wherein the linear position sensor further comprises a magnetic field detection sensor.

9. The mimic gauge recited in claim 2, wherein the position sensor is an angular position sensor for measuring spatial positions of the motional member along a generally curvilinear path.

10. The mimic gauge recited in claim 9, wherein the angular position sensor further comprises a range arm secured to the mechanical coupler.

11. The mimic gauge recited in claim 6, wherein the angular position sensor further comprises a potentiometer.

12. The mimic gauge recited in claim 6, wherein the mechanical-to-electrical converter further comprises a magnetic field source generator secured to the mechanical coupler, and wherein the angular position sensor further comprises a magnetic field detection sensor.

13. The mimic gauge recited in claim 6, wherein the mechanical-to-electrical converter further comprises a light source and an optical reflector secured to the mechanical coupler, and wherein the angular position sensor further comprises an optical position sensor.

15. The mimic gauge recited in claim 6, wherein the angular position sensor is an inclinometer.

14. The mimic gauge recited in claim 6 further comprising a stationary adapter, said stationary adapter providing a stationary reference for the mechanical-to-electrical converter.

16. The mimic gauge recited in claim 3, wherein the angular position sensor is an inclinometer.

17. The mimic gauge recited in claim 4, wherein the angular position sensor is an inclinometer.

18. The mimic gauge recited in claim 1, wherein the field processor further comprises a temperature sensor.

19. The mimic gauge recited in claim 1, wherein the field processor further comprises a transmitter for transmitting one of the electrical position signals and the position data to a remoter location.

20. The mimic gauge recited in claim 1, wherein the memory includes capacity for storing one of the electrical position signals and the position data.

21. The mimic gauge recited in claim 1, wherein the field processor further includes a calibration algorithm for producing calibrated measurement data representative of readings from a measurement instrument that is mechanically coupled to the chart recorder from the electrical position signals.
